(19) United States
(12) Patent Application Publication
(10) Pub. No.: US 2008/0207042 A1
(43) Pub. Date: Aug. 28, 2008

(54) Connector for Wearable Electronics

(75) Inventors: Ralf Schmidt, Aachen (DE); Knut Dahlhoff, Aachen (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., Eindhoven (NL)

(21) Appl. No.: 11/723,000

(22) PCT Filed: Dec. 22, 2005
(86) PCT No.: PCT/IB2005/054382

§ 371 Date: Jun. 28, 2007

(30) Foreign Application Priority Data
Dec. 30, 2004 (EP) 04107062.4

(51) Int. Cl. H01R 13/64

(52) U.S. Cl. 439/374

(57) ABSTRACT

An electrical connector is described which comprises a first unit, a second unit, each unit bearing an electrical contact, the first unit comprising a protruding portion (103), the second unit comprising a receiving portion (102), wherein both the protruding portion and the receiving portion have substantially planar matching shapes, the protruding portion is arranged to be insertable into the receiving portion along an axis substantially perpendicular to each substantially planar matching shape, and the protruding portion and the receiving portion are arranged to be rotatable relative to each other about the axis thereby bringing the electrical contacts into alignment. The connector is particularly suitable for use in wearable electronics and solves the problem of how to arrange a connector which is easy to connect up, particularly by the old or infirm.

The invention relates to an electrical connector, comprising a first unit and a second unit, each unit bearing an electrical contact, the first unit comprising a protruding portion, the second unit comprising a receiving portion.

U.S. Pat. No. 5,326,272 describes a connector in which a first unit is brought into connection with a second unit by sliding a small protruding portion, attached to a back plate, laterally into the narrow channel of a second unit. The channel comprises a blind end to restrict any further lateral motion. Electrical connection is made when the protruding portion, which is itself conducting and therefore provides a point of electrical connection, makes contact with electrical wires around the channel. The entrance to the channel is flared slightly to allow a slight ease of connection. The walls of the channel are not parallel and thereby restrain the protruding portion from any vertical motion while situated inside the second unit. The connector allows a good electrical contact to be made but making the connection is not always easy to achieve. In particular an elderly or infirm user might experience a considerable degree of difficulty in correctly lining up the protruding portion of the first unit with the entrance on the second unit and correctly sliding it in.

It is an object of the invention to provide a connector which is easier to use. This is achieved by the invention whereby both the protruding portion and the receiving portion have substantially planar matching shapes, and further the protruding portion is arranged to be insertable into the receiving portion along an axis substantially perpendicular to each substantially planar matching shape, and further the protruding portion and the receiving portion are arranged to be rotatable relative to each other about the axis thereby bringing the electrical contacts into alignment.

An electrical connector allows connection between an object, requiring electricity for at least part of its use, and the source of that electricity. The source may be any such electricity source and includes battery power and mains power, amongst others. For the connector to set the object in the correct electrical contact with the electricity source the various parts of the connector must be connected up with each other in a proper manner. The invention provides a connector with individual parts which connect up in a different manner to the individual connector parts of the prior art. As a result of the arrangement of the invention those parts are easier to connect. The connector of the invention comprises two parts, or units, one which is essentially a receiving part, or unit, bearing a receiving portion arranged to provide a port or recess for the other part, or unit. The other part is essentially an inserting part, or unit, which bears a protruding portion which is itself inserted into the receiving portion. Once the protruding portion is inserted, the inserting part is twisted relative to the receiving part and the electrical connection points on each part are brought into alignment.

The inserting part comprises a substantially planar, or flat, protruding portion which bears a shape. The same or similar shape is applied to the receiving portion, in that the receiving portion bears essentially the same shape as the protruding portion, thus allowing the shapes to match up with each other. The receiving portion comprises a sunken or depressed area, or hole, whose sides form the same or similar shape to the shape of the protruding portion. Since the shape of the protruding portion is substantially planar, or flat, and the receiving portion is shaped to receive it, the shape of the receiving portion in the receiving part is therefore also substantially planar.

To match up the units the user is simply required to align the shapes before inserting the protruding matching shape into the receiving matching shape. This is easily and simply achieved because it can be seen and felt by the user that the receiving portion and protruding portion have the same or essentially similar shape. The act of inserting the protruding portion into the receiving portion becomes one of matching up the shapes.

Once inserted, the two portions are rotated relative to each other. This is also a simple procedure. Most shapes can be manually rotated around an imaginary reference axis substantially perpendicular to the shape, situated, say, at the geometric center of gravity of the shape. The direction along which the protruding portion is inserted into the receiving portion is also along the direction of the line of this axis. In the invention, the two shapes are rotated relative to each other around this axis.

Physical contact is made between the corner, or angular, portions of the protruding portion and the side portions of the receiving portion once the two portions have been rotated relative to each other.

The electrical contacts correctly situated at these points of contact are now lined up and the connection process is achieved.

It is therefore easy to insert one part on the connector inside the other and rotate the two relative to each other to make an electrical connection. The connector of the invention is therefore easy to manipulate and is therefore easier to use.

The connector is arranged to be substantially, or essentially, flat. It is therefore particularly suitable for incorporation into wearable electronics, for example wearable or portable sensors, monitors and therapeutic equipment. Example of such wearable electronics are heart monitor equipment and TENS machines. Because the connector is substantially flat it can be arranged to lie flat against the skin or against clothing and therefore does not protrude into the body of the wearer. It is also less likely to rub or abrade clothing or other worn materials.

Advantageous dimensions for the receiving portion are between 2 to 4 millimeters deep. However a depth of 6 millimeters is also acceptable and quite comfortable to wear. In the embodiment in which the receiving portion is a depression and there is a floor portion it is clearly not as deep and so a depth of 2 to 5 millimeters is acceptable. A suitable width for the entire arrangement is a trade-off between making the connector large enough to be easy to manipulate and small enough to be comfortable to wear. A diameter or width of the receiving part between 2 and 3 cm is quite suitable. A diameter for the protruding portion and any plate attached to the protruding portion can then be suitably arranged.

It is relatively easy to match up shapes and insert one into the other. The shape allocated to the protruding and receiving portions may be any shape which is easy to recognize and easy to match, or line up, with itself. The criteria by which a shape becomes easy to align with itself is one by which it has identifying features which allow it to be recognizable and capable of orientation in a reproducible way. Such features include angles between sides, sides of definable lengths, sides of certain shapes or indeed any feature which is noticeable. The requirement that the shape be rotated within another shape requires that there be a certain regularity to the shape allowing some degree of turning of one shape within the other.

Therefore in a useful embodiment of the invention the shapes are substantially polygonal, in particular comprising shapes that are substantially regular polygons. The overall term substantially, or essentially, regular polygon indicates that the shape is predominantly that of a regular polygon without necessarily being a pure mathematical shape. Therefore it may, for example, have slightly curved sides instead of sides which are exactly straight, such curves being convex, meaning that the substantially polygonal shape has sides which bow out, or concave, meaning that they bow in. Similarly the corners of the substantially polygonal shape may be rounded for ease of turning the protruding shape inside the receiving shape, and not sharp as in a strictly regular polygon.

A particularly useful embodiment of the substantially polygonal shape is a shape which is substantially triangular. This is essentially a three sided shape, each side being slightly bowed in a convex manner, the sides meeting at corner sections which are slightly rounded. This is a particularly useful embodiment because when the substantially triangular protruding portion is inserted into the substantially triangular receiving portion and rotated to make contact, the contact is made between the three corners of the protruding portion and the three sides of the receiving portion. These three points of contact define a plane and make a stable connection between both parts of the connector.

Other useful shapes include an essentially square shape with rounded corners, an essentially pentagonal shape, an essentially hexagonal shape, an essentially heptagonal shape and an essentially octagonal shape. All of these shapes can be easily recognized and manipulated by the user.

The fact that the shapes of both the protruding and receiving portion can be perceived by touch is particularly advantageous if the connector is being used under levels of low or very low light, in other words, in the dark, or used by someone with reduced or little or no vision.

The protruding portion is arranged to be smaller than the receiving portion so that it can easily fit inside it and rotate. In fact it is advantageous if the protruding portion is arranged to be dimensioned so that it can turn completely inside the receiving portion. In the case of an essentially regular polygonal shape it is advantageous if the protruding portion is arranged so that it can be rotated completely inside the receiving portion so that it lines up symmetrically within the receiving portion.

It is a further advantage of using a substantially, or essentially, triangular shape that it allows a wide degree of clearance between the protruding portion and the receiving portion while allowing the arrangement of a protruding portion which can be completely rotated inside the receiving portion and allows contact to be made when the corner portions of the protruding portion line up with the side portions of the receiving portion.

In order to ensure electrical connection is made, the electrical contacts should be situated in the areas, or sections, of the protruding and receiving portions which make contact with each other once the two portions have been rotated relative to each other. In the case of substantially regular polygonally shaped portions, electrical contacts are situated at the corners of the polygonal shape on the protruding portion and half way along each side on the inside of the polygonal shape of the receiving portion. This provides a further advantage in using a substantially polygonal shape because the points at which electrical contacts can be situated are easy to identify on each shape.

The size and shape of the two units may vary. In one embodiment, the receiving part and the inserting part are small flat carriers, essentially broader than they are deep. The inserting unit is invested with a flat plate which forms the back of the protruding portion. This back provides a grip surface to allow easy manipulation. The receiving portion, which is essentially a hollow in the receiving unit, is formed by walls and has a floor portion at the base. The outer side of the receiving unit, below the receiving portion, also provides a grip surface to allow easy manipulation.

The inclusion of a grip surface on either the top surface or the bottom surface, or both, makes it easy for the user to secure a good purchase on the connector, thus making it even easier to use. Such a grip may be provided by adding a mat or covering of some material which provides a high coefficient of static friction between itself and human skin. An example of this would be rubber. The mat or covering may be provided in a section and sunk into either surface. Alternatively, it may be provided by the creation of a series of shallow parallel grooves in the material of the surfaces.

A useful embodiment comprises receiving and inserting units which are arranged to form a closed unit when correct connection is achieved. In such an embodiment, a protruding portion with a plate attached is inserted into the receiving portion. The plate is arranged to cover the receiving portion completely when the protruding portion is rotated correctly with respect to the receiving portion. This embodiment ensures that no extra contact can be made with any electrical components when the connector is in operation.

A particularly interesting embodiment is to construct the receiving portion as a closed loop, or ring, of material shaped according to the matching shape on the protruding portion. The protruding portion is thus inserted into the loop and rotated, according to the invention. Various features may be incorporated into the protruding portion or the inserting unit to ensure that a suitable connection is achieved and maintained. For example, the inclusion of both a beveled edge on the protruding portion and a flat plate on the inserting part, both arranged so that the portions of the closed loop with which contact is made fits into the space between the plate and the angle of the beveled edge ensures that the arrangement is held in contact once both portions have been rotated relative to each other. In an alternative embodiment, suitable for use with the closed loop receiving portion, the inserting portion is a flat unit formed into the substantially matching planar shape of the protruding portion, with a concave channel running around the edge. When the protruding portion is inserted into the receiving portion and one is rotated relative to the other the loop fills the space of the concave channel at the points where connection is made.

A particularly advantageous embodiment of the invention is to ensure correct rotation and consequent correct alignment of the electrical contacts by the provision of beveled, or chamfered, edges along the edge of each substantially planar matching shaped portion. The beveled edges situated on each portion cooperate with each other to ensure that the protruding portion rotates into the correct relative depth within the receiving portion. To achieve this, the beveled edge, or edges, of the protruding portion slides under the corresponding beveled edge, or edges, of the receiving portion as the two portions are rotated relative to each other. Each portion may have one continuous beveled edge running around the perimeter of the substantially planar matching shaped portion or may have several such beveled edges situated at intervals. A particularly useful embodiment, when several beveled edges are situated at intervals, is to arrange them to be placed one on each side of the substantially polygonally shaped portion.

Once the protruding portion and the receiving portion have been rotated relative to each other the connection should be maintained so that the connector can function successfully. Significantly, the electrical contact can be maintained by friction, but other solutions may be added such as a release catch which engages when both portions have the correct arrangement relative to each other. An example of such a release catch is a spring loaded ball sunk into either the receiving portion or protruding portion which is released partically into a corresponding receptor in the other portion when both portions align correctly. Alternatively, the use of small cut-outs in the sides of the receiving portion also allows a degree of locking when the corners of the protruding portion slide into the cut-out portion. A rotational locking can be integrated into the receiving and inserting portions which engages when the two portions are orientated in the contact position. If the locking is an eccentrically placed pin in one or other portion, with a corresponding eccentrically placed port in the other portion, the locking mechanism has the further advantage that it allows the user to orientate both portions in only one orientation. This is useful if the electrical contacts must be made in a single unique way.

The electrical contacts are arranged so that they line up once the connection process is completed. There are various ways in which this may be achieved. One embodiment is to arrange for electrical contact points for all electrical leads to be provided at all corners of the protruding portion and at all corresponding points of connection on the receiving portion. An arrangement, not part of the invention, within the electronics connected via the connector ensures that correct electrical functioning occurs.

Alternatively, as a specialized embodiment of the above embodiment, electrical contact points to only one corner of the protruding portion or only one point of connection on the receiving portion are connected up. In this embodiment, an arrangement within the electronics, again, not part of the invention, connected via the connector ensures that the correct electrical contact is made through only the corresponding electrical contact points on the other portion.

Alternatively, embodiments of the invention in which connection is constrained or indicated in a specific way are now described.

In one embodiment, the electric leads, which are arranged to be attached to the inserting unit and receiving unit, and the electric contact points in each unit, are all positioned so that when the protruding portion is inserted into the receiving portion and rotated to complete connection, the two leads line up opposite each other and the electric contact points are correctly aligned. The embodiment has the advantage that it is intuitive to connect.

In an alternative embodiment, a step, slat or shallow bridge is positioned inside the receiving unit with a corresponding cut or section removed from the substantially matching planar shape of the protruding section. This ensures that insertion and connection can only be arranged at a relative orientation of the two units which brings the electrical contacts into correct alignment. A further addition to this embodiment includes the incorporation of a mechanism to prevent the user, having once correctly inserted the protruding portion into the receiving portion according to the position of the step or like, from accidentally turning either the protruding portion or receiving portion relative to the other in the wrong direction and so incorrectly lining up the contacts. Such a mechanism could be, for example, the inclusion of a convex edge, as viewed from above, on one side thus hindering that particular side from being turned into the step. An alternative mechanism is a click-locking corner.

A further solution to the problem of how to arrange the connector so that it can be aligned in such a way that not only physical connection is made between the electrical contacts but that correct electrical connection is made thus allowing correct electrical operation, is by the following advantageous embodiment. The sides of the protruding and receiving portions arranged to align with each other are further arranged with a corresponding curvature when viewed in cross section. So for example one combination of receiving and protruding portion interaction could include a convex curvature to the side of the protruding portion, interacting with a concave curvature on the corresponding side of the receiving portion. A second combination could then include a concave curvature to the side of the protruding portion, interacting with a convex curvature on the corresponding side of the receiving portion. The third combination could then include both corresponding sides being straight. As will be appreciated, this embodiment is particularly advantageous when applied to the connector embodiment with three sides.

Once physical connection between the two units is achieved, the electrical contacts can also be brought into contact with each other by applying a spring loading to the electrical connection points.

The invention also relates to a connection unit for an electrical connector for insertion into a further unit, the connection unit bearing an electrical contact and the connection unit comprising a protruding portion, the protruding portion having a substantially planar shape which is arranged to be insertable along an axis substantially perpendicular to the substantially planar shape into a corresponding receiving portion situated on the further unit and arranged to be rotatable relative to the corresponding receiving portion.

The invention also relates to a connection unit for an electrical connector for receiving a further unit, the connection unit bearing an electrical contact and the connection unit comprising a receiving portion, the receiving portion having a substantially planar shape which is arranged to receive a corresponding protruding portion along an axis substantially perpendicular to the substantially planar shape, the corresponding protruding portion situated on the further unit and arranged to be rotatable relative to the corresponding protruding portion.

Both connection units are suitable for connecting with each other to form the connector of the invention.

These and other aspects of the invention are explained using the following Figures.

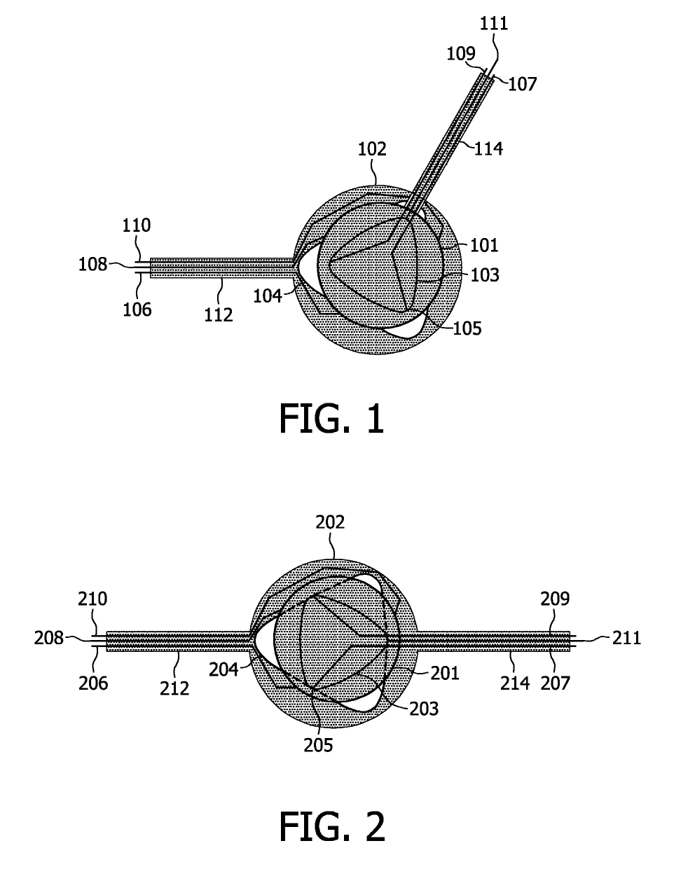

FIG. 1 shows an embodiment of the invention in which the inserting part is inserted into the receiving part.

FIG. 2 shows the same embodiment of the invention in which the inserting part and the receiving part have been rotated relative to each other. The position of the protruding portion relative to the receiving portion is shown.

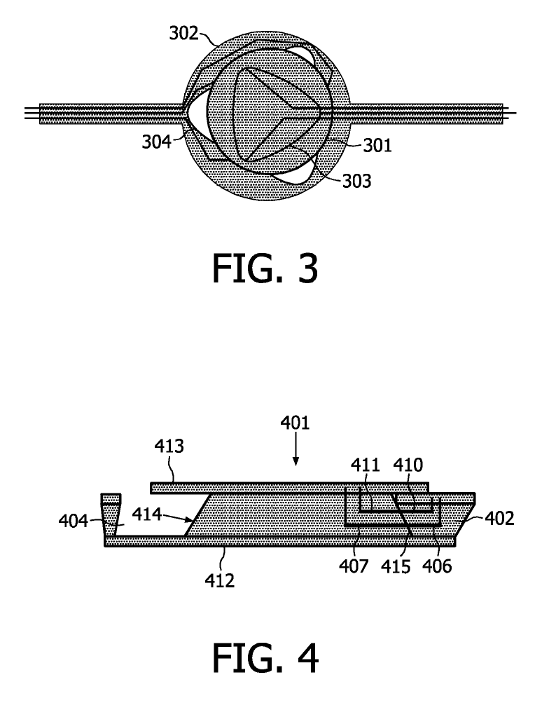

FIG. 3 shows the same embodiment of the invention but without guide lines indicating the position of the sides of the receiving portion relative to the protruding portion.

FIG. 4 shows the same embodiment of the invention, viewed in vertical cross-section.

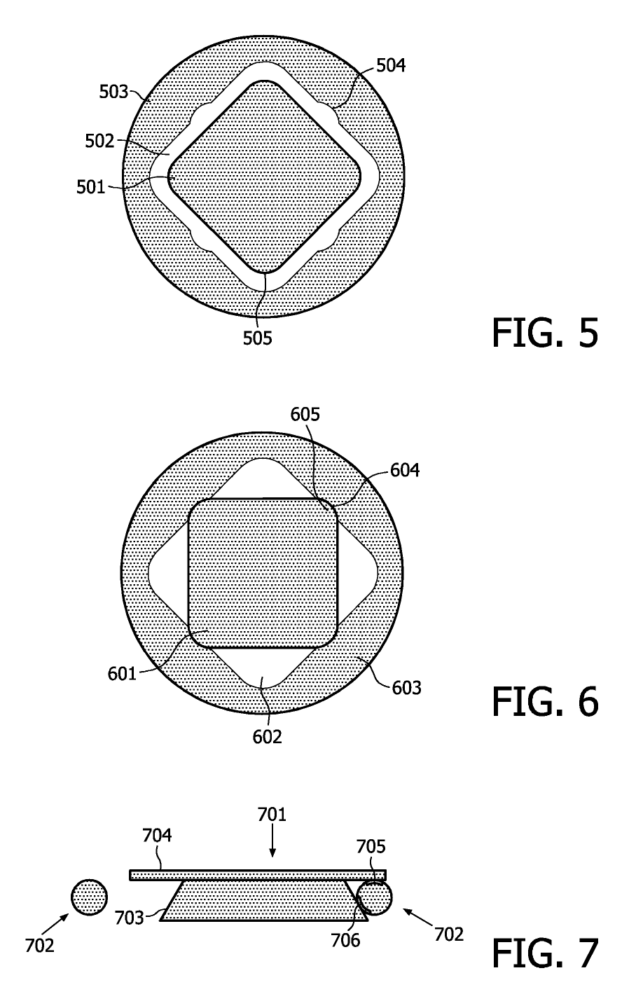

FIG. 5 shows a further embodiment of the invention in which the protruding and receiving portions are substantially square and in which the protruding portion is inserted into the receiving portion.

FIG. 6 shows the same embodiment of the invention in which the substantially square protruding and receiving portions are rotated relative to each other.

FIG. 7 shows the closed loop embodiment of the invention in vertical cross-section.

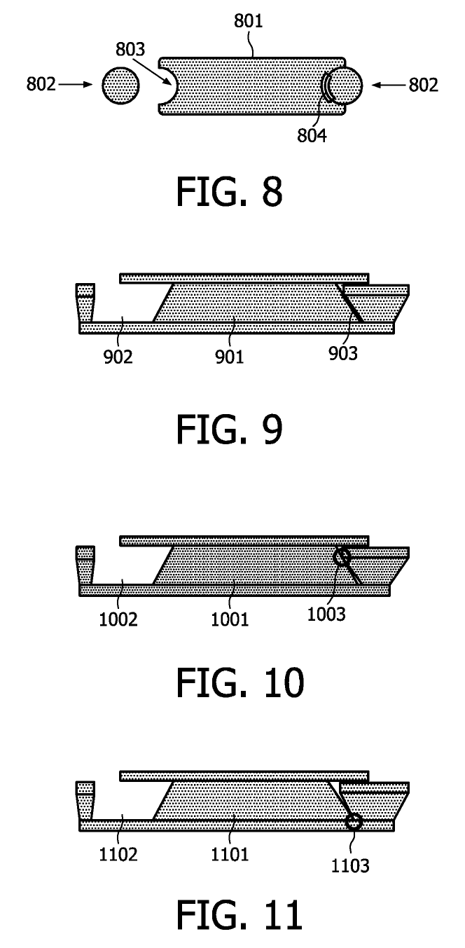

FIG. 8 shows a further closed loop embodiment in which the protruding portion has concave edges.

FIG. 9 shows an embodiment of the invention in which the angle of the beveled edges on the receiving portion and the protruding portion are equal.

FIG. 10 shows an embodiment of the invention in which the angle of the beveled edges on the receiving portion and the protruding portion are not equal.

FIG. 11 shows an embodiment of the invention in which the angle of the beveled edges on the receiving portion and the protruding portion are also not equal.

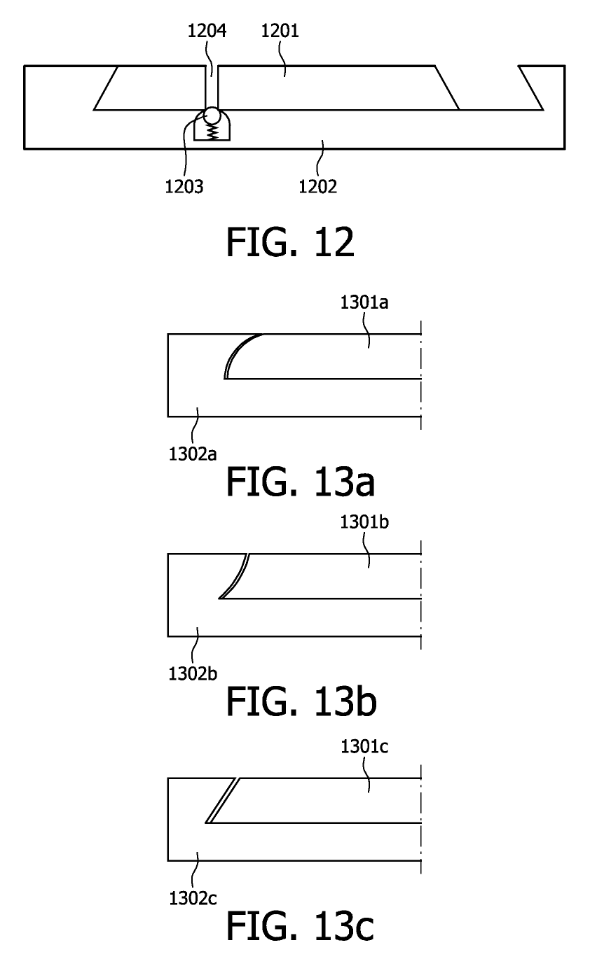

FIG. 12 shows the embodiment of a spring release catch in the form of a spring loaded ball, as used in the invention.

FIG. 13 shows a further embodiment which helps to ensure correct alignment between the electrical connectors.

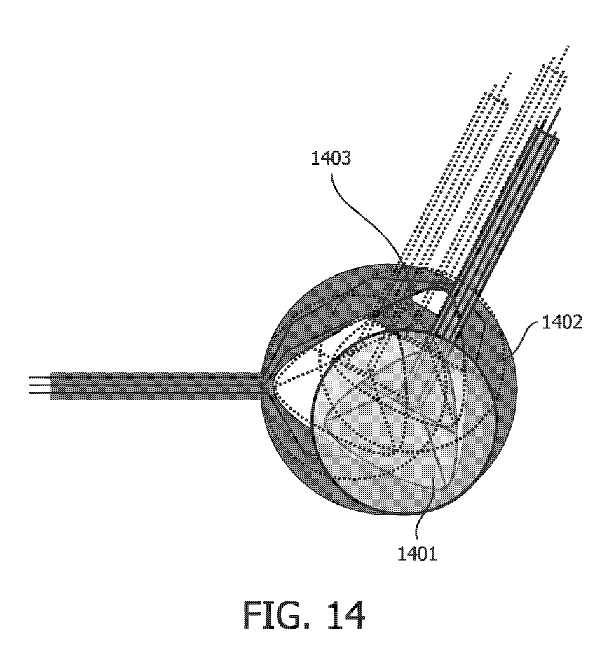

FIG. 14 shows the alternative embodiment of the step, slat or shallow bridge as used in the invention.

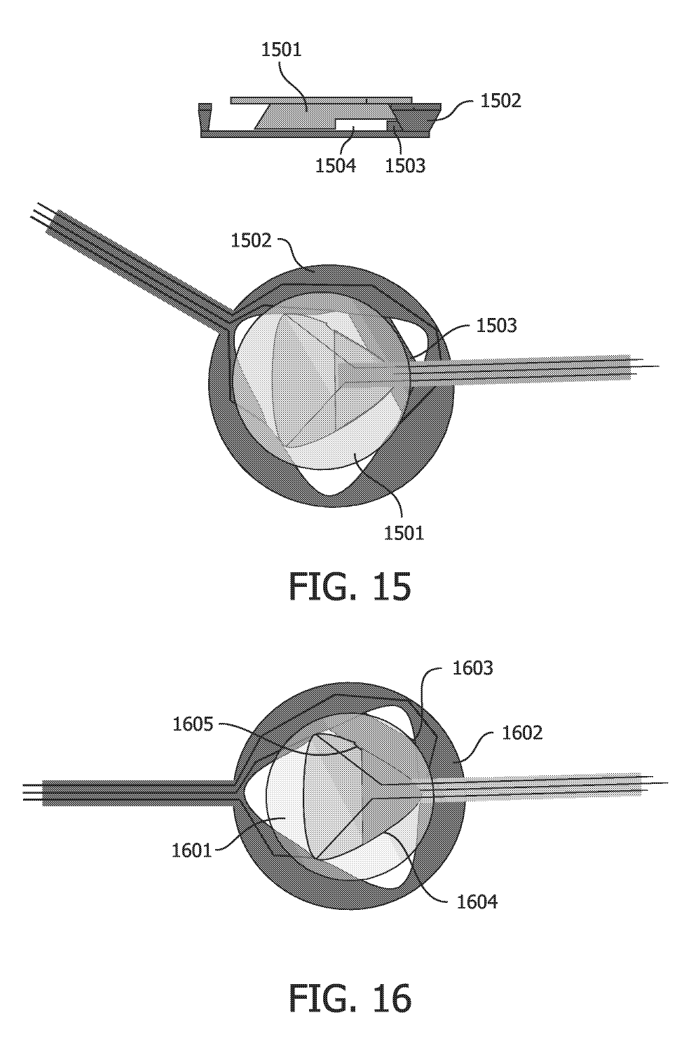

FIG. 15 shows further details of the embodiment of FIG. 14.

FIG. 16 shows a further addition to the embodiment of FIG. 14.

FIG. 1 shows an embodiment of the invention in which an inserting part 101, comprising a protruding portion 103, is inserted into a receiving part 102, comprising a receiving portion 104. Both the protruding portion 103 and the receiving portion 104 are substantially triangular. The substantially triangular shape of the protruding portion has essentially rounded corners 105. Further there are shown two leads, 112 and 114 connected to the receiving part 102 and inserting part 101 respectively, each lead bearing electrical wires 106, 107, 108, 109, 110 and 111 which make contact with each via electrical contact points carried on the protruding and receiving portions 103 and 104. FIG. 1 shows the orientation of the inserting part 101 and the receiving part 102 after the protruding portion 103 is inserted into the receiving portion 104, but before the inserting part 101 and the receiving part 102 are rotated relative to each other. There is clearance between the sides of the protruding portion 103 and the sides of the receiving portion 104 to allow the protruding portion 103 to fit inside the receiving portion 104.

FIG. 2 shows the same embodiment of the invention in which the inserting part 201 and the receiving part 202 have been rotated relative to each other. The position of the protruding portion 203 relative to the receiving portion 204 is shown and it can be seen that the corners 205 of the protruding portion 201 now make contact with the sides of the receiving portion 204. Electrical contact points situated at the points of physical contact allow contact to be made between the contacts 206 and 207, between 208 and 209, and between 210 and 211, carried in leads. This embodiment also shows how the position of the electrical contacts can be arranged to make correct electrical connection when the leads, 211 and 212, are opposite each other.

FIG. 3 shows the same arrangement of FIG. 2 but without guide lines indicating the position of the sides of the receiving portion 304 relative to the protruding portion 303.

FIG. 4 shows the same embodiment of the invention, viewed in vertical cross-section. The inserting part 401 is shown with the protruding portion 403 inserted into the receiving portion 404 of the receiving part 402. The protruding portion is attached to a fixed plate 413. The receiving portion 404 is bounded by a floor portion 412. The provision of the plate 413 which is wider than the protruding portion and arranged to project over the edges of the receiving portion 404 when the protruding portion 403 and the receiving portion 404 are rotated relative to each other limits the vertical movement of the protruding portion 403 relative to the receiving portion 404. The floor portion 412 of the receiving portion 404 has a similar effect. In fact, both are not necessary concurrently in the embodiment but the provision of both allows an arrangement which is comfortable to use, easy to manually manipulate and which reduces the possibility of dirt and small particles from entering the connector and clogging up the mechanism or obstructing the making of a clean electrical contact. Electrical wires 406, 407, 410 and 411 are shown making contact with each other. A beveled edge 414 is visible. This makes a physical connection with a corresponding beveled edge 415 of receiving portion 404.

FIG. 5 shows a further embodiment of the invention in which the protruding portion 501 and the receiving portion 502, in receiving part 503, are substantially square and in which the protruding portion 501 is inserted into the receiving portion 502. The remainder of the inserting part is not shown. In this particular embodiment the sides of the receiving portion have small bowed, or concave, cut-out sections 504 to receive the rounded corners 505 of the protruding portion 501. In general, in the embodiments in which the matching shape is substantially polygonal, as the number of sides of the polygon increases the initial clearance as well as the allowed manufacturing tolerances decrease. Spring loading of electrical contacts then becomes advisable. The use of small cut-outs in the sides of the receiving portion also allows a degree of locking of the protruding portion in place while contact is maintained.

FIG. 6 shows the same embodiment of the invention shown in FIG. 5. The substantially square protruding portion 601 and the receiving portion 602 are shown rotated relative to each other. The corner portions 605 and the cut-out portions 604 are shown in contact.

FIG. 7 shows the closed loop embodiment of the invention in vertical cross-section. The protruding portion 701 is similar to the protruding portion of the embodiment shown in FIG. 4. The receiving portion, not clearly shown, is provided by the shape of the loop viewed from above. In this case the material of the loop is formed in cross-section into a cable shape and thus provides two points of contact 705 and 706 wherever the receiving portion makes contact with the protruding portion. The protruding portion 701 is shown with an attachment plate 704 which stops the protruding portion from falling through the receiving portion. FIG. 7 shows the closed loop embodiment applied to a substantially triangular matching shape, for easy comparison of features with FIG. 4.

FIG. 8 shows a further closed loop embodiment in which the protruding portion 801 has concave edges 803. These make contact with the closed loop of the receiving portion 802 over area 804.

Points of contact on the embodiments which include beveled edges can be defined using different angles of bevel.

FIG. 9 shows an embodiment of the invention in which the angle of the beveled edges on the receiving portion 902 and the protruding portion 901 are equal. Therefore contact 903 is made between the two portions along a line of contact. Electrical contact points can be arranged anywhere along this line. In reality only a finite point along the line will make contact in strict geometrical terms, however this point does not need to be defined, allowing for manufacturing tolerances.

FIG. 10 shows an embodiment of the invention in which the angle of the beveled edges on the receiving portion 1002 and the protruding portion 1001 are not equal. Contact 1003 is therefore made at a point. The advantage of having only one point of contact is that no spring loading of electrical contacts is required.

FIG. 11 shows another embodiment of the invention in which the angle of the beveled edges on the receiving portion 1102 and the protruding portion 1101 are also not equal, therefore allowing point of contact 1103.

FIG. 12 shows the embodiment of a spring release catch in the form of a spring loaded ball 1203 situated inside the receiving portion 1202 and aligned to release partially into a receptor 1204 situated in the protruding portion 1201.

FIG. 13 shows a further embodiment which helps to ensure correct alignment between the electrical connectors. The sides of the protruding and receiving portions arranged to align with each other are further arranged with a corresponding curvature when viewed in cross section. FIG. 13a shows a combination of receiving and protruding portion interaction which includes a convex curvature 1301a to the side of the protruding portion, interacting with a concave curvature 1302a on the corresponding side of the receiving portion. A second combination includes a concave curvature 1301b to the side of the protruding portion, interacting with a convex curvature 1302b on the corresponding side of the receiving portion. The third combination includes both corresponding sides 1301c and 1302c being straight.

FIG. 14 shows the alternative embodiment of the step, slat or shallow bridge. A protruding portion 1401 is seen as it is moved into alignment with a receiving portion 1402 comprising a step 1403.

FIG. 15 shows the same protruding portion 1501 as it is brought more into alignment with the receiving portion 1502 comprising step 1503. The protruding portion can be seen to have a cut-away portion 1504 to accommodate the step 1503. This ensures that insertion and connection can only be arranged at a relative orientation of the two units which brings the electrical contacts into correct alignment.

FIG. 16 shows a further addition to this embodiment, the incorporation of a mechanism to prevent the user, having once correctly inserted the protruding portion into the receiving portion according to the position of the step or like, from accidentally turning either the protruding portion or receiving portion relative to the other in the wrong direction and so incorrectly lining up the contacts. FIG. 16 shows two possible mechanisms, the inclusion of a convex edge 1604, as viewed from above, hindering side bearing the convex edge from being turned into the step, and a click-locking corner 1605 which interacts with the step 1603.

It can thus be seen that the invention allows provision of a simple connector suitable for use by elderly and infirm patients.

1. An electrical connector, comprising a first unit and a second unit, each unit bearing an electrical contact, the first unit comprising a protruding portion, the second unit comprising a receiving portion, wherein both the protruding portion and the receiving portion have substantially planar matching shapes, and further the protruding portion is arranged to be insertable into the receiving portion along an axis substantially perpendicular to each substantially planar matching shape, and further the protruding portion and the receiving portion are arranged to be rotatable relative to each other about the axis thereby bringing the electrical contacts into alignment.

2. An electrical connector as claimed in claim 1, wherein the first unit and the second unit are substantially flat.

3. An electrical connector as claimed in claim 1, wherein the substantially planar matching shapes of the protruding portion and the receiving portion are substantially polygonal shapes.

4. An electrical connector as claimed in claim 3, wherein the substantially polygonal shape is substantially triangular.

5. An electrical connector as claimed in claim 1, wherein the protruding portion and the receiving portion are proportioned so that the protruding portion is insertable inside the receiving portion with a substantially wide clearance.

6. An electrical connector as claimed in claim 1, wherein the protruding portion and the receiving portion each further comprise a beveled edge arranged on the circumference of each substantially planar matching shape, the beveled edge of the receiving portion arranged to retain the beveled edge of the receiving portion when the protruding portion and the receiving portion are rotated relative to each other.

7. An electrical connector as claimed in claim 1, wherein the receiving portion comprises a closed loop formed into the substantially planar matching shape.

8. An electrical connector as claimed in claim 3, wherein the electrical contact on the protruding portion is arranged to be situated in substantially a corner region of the shape, and further the electrical contact on the receiving portion is arranged to be situated in substantially a corner region of the shape.

9. A connection unit for an electrical connector, bearing an electrical contact, the unit comprising a protruding portion, wherein the protruding portion has a substantially planar shape which is arranged to be insertable into a corresponding receiving portion along an axis substantially perpendicular to the substantially planar shape.

10. A connection unit as claimed in claim 9, wherein it is substantially flat.

11. A connection unit as claimed in claim 9, wherein the substantially planar shape is a substantially polygonal shape.

12. A connection unit for an electrical connector, bearing an electrical contact, the unit comprising a receiving portion, wherein the receiving portion has a substantially planar shape which is arranged to receive a corresponding protruding portion along an axis substantially perpendicular to the substantially planar shape.

13. A connection unit as claimed in claim 12, wherein it is substantially flat.

14. A connection unit as claimed in claim 12, wherein the substantially planar shape is a substantially polygonal shape.

15. The electric connector of claim 1 further comprising a spring release catch for maintaining alignment of the electric contacts.

16. The electric connector of claim 1 further comprising a means for allowing rotation in only a single direction.

17. The electric connector of claim 3, wherein the substantially polygonal shape is square, pentagonal, hexagonal, or octagonal.

18. The electric connector of claim 1, wherein the receiving portion and the protruding portion each have mating beveled edges for alignment of the electric contacts.

19. An electrical connector comprising:
a first substantially polygonal unit including a protruding portion and an electrical contact; and
a second substantially polygonal unit including a receiving portion and an electrical contact;
wherein the electrical contacts of the first and second units are aligned by insertion of the protruding portion into the receiving portion and rotating the protruding portion and receiving portion relative to one another.

20. The electric connector of claim 19, wherein the first and second units are substantially flat.
